(19) United States
(12) Patent Application Publication
(10) Pub. No.: US 2007/0046777 A1
(43) Pub. Date: Mar. 1, 2007

(54) Three-dimensional display device

(76) Inventors: Myoung-Seop Song, Yongin-si (KR); Jang-Doo Lee, Yongin-si (KR); Hyoung-Wook Jang, Yongin-si (KR); Hui Nam, Yongin-si (KR); Beom-Shik Kim, Yongin-si (KR)

Correspondence Address: CHRISTIE, PARKER & HALE, LLP, PO BOX 7068, PASADENA, CA, 91109-7068, US

(21) Appl. No.: 11/512,619

(22) Filed: Aug. 29, 2006

(30) Foreign Application Priority Data
Aug. 29, 2005 (KR) 10-2005-0079321

(51) Int. Cl. H04N 13/04

(52) U.S. Cl. 348/56

(57) ABSTRACT

A three-dimensional display device includes an image display portion including sub-pixels corresponding to left eye images and right eye images and a light control portion facing the image display portion. The light control portion may include light interception portions and light transmission portions alternately and repeatedly arranged along a first direction of the image display portion. The range of the width M of the sub-pixels may be equal or greater than ½ times the pitch L of the sub-pixels and less than the pitch L of the sub-pixels. The range of the width b of the light transmission portions may be equal or greater than (L−M) and equal or less than (L/0.62−M).

### CROSS-REFERENCES TO RELATED APPLICATION

This application claims priority to and the benefit of Korean Patent Application No. 10-2005-0079321 filed on Aug. 29, 2005, in the Korean Intellectual Property Office, the entire content of which is incorporated herein by reference.

### BACKGROUND OF THE INVENTION

1. Field of the Invention

The present invention relates to a three-dimensional display device, and in particular, to an autostereoscopic three-dimensional display device using a parallax barrier.

2. Description of the Related Art

Generally, three-dimensional display devices supply different views to the left and right eyes of a user such that the user can have depth perception and stereoscopic perception of the viewed image.

The three-dimensional display devices may be categorized as a stereoscopic display device where the user should wear viewing aids such as polarizing glasses, or an autostereoscopic display device where the user can see the desired three-dimensional image without wearing such viewing aids.

A common autostereoscopic display device utilizes an optical separation element such as a lenticular lens, a parallax barrier, or a microlens array to spatially separate or isolate the left-eye image part and the right-eye image part displayed at an image display unit in the directions of the left and right eyes of the user, respectively.

In particular, the parallax barrier may be formed with a liquid crystal shutter utilizing a transmission type of liquid crystal display, and in this case, it may be converted between a two-dimensional mode and a three-dimensional mode. Thus the parallax barrier can be easily applied to laptop computers or cellular phones.

Generally, the parallax barrier includes stripe-shaped light interception portions and light transmission portions. It selectively separates left and right eye images displayed at the image display unit through the light transmission portions such that the left and right eye images are respectively provided to the left and right eyes of the user. When the parallax barrier is adapted to the three-dimensional display device, locations of the left eye and the right eye of the user are limited due to optical paths. This makes the user feel inconvenience when watching three-dimensional images.

The aperture ratio of the parallax barrier can be reduced in order to prevent limitation of viewing range. However as a result of this, the brightness of the three-dimensional display device may be reduced. Accordingly, the quality of the three-dimensional image may be deteriorated. Therefore, there is a need for a three-dimensional display device, which can display three-dimensional images, that has a wide viewing range and high brightness.

### SUMMARY OF THE INVENTION

In exemplary embodiments according to the present invention, a three-dimensional display device with one or more of the following features is provided.

A three-dimensional display device includes an image display portion including sub-pixels corresponding to left eye images and sub-pixels corresponding to right eye images and a light control portion facing the image display portion.

The light control portion may include light interception portions and light transmission portions and repeatedly arranged along a first direction of the image display portion.

The range of the width M of the sub-pixels may be equal or greater than ½ times the pitch L of the sub-pixels and less than the pitch L of the sub-pixels. The range of the width b of the light transmission portions may be equal or greater than (L−M) and equal or less than (L/0.62−M). The light control portions may be formed with a liquid crystal shutter.

The liquid crystal shutter may include a first substrate, a second substrate facing the first substrate, first and second electrodes respectively located on the inner surfaces of the first and second substrates, a pair of alignment layers covering the first and second electrodes, and a liquid crystal layer disposed between the alignment layers.

One of the first and second electrodes may be formed in the same pattern as that of the light interception portions. The light control portions may include a transparent plate and an opaque layer located on a surface of the transparent plate and may be formed in the same pattern as that of the light interception portions. The light interception portions and the light transmission portions may have a stripe pattern elongated along a second direction that is perpendicular to the first direction.

The sub-pixels corresponding to the left eye images and the sub-pixels corresponding to the right eye images may be alternately and repeatedly arranged along the first direction. The aperture ratio of the light control portions may have a range of equal or greater than 0.25 and equal or less than 0.55 or less.

The image display portions may include left eye pixels consisting of three sub-pixels corresponding to left eye images and right eye pixels consisting of three sub-pixels corresponding to right eye images. The range of the width of the pixels M₂ may be equal or greater than ½ times the pitch L₂ of the left eye pixels and the right eye pixels and less than the pitch L₂. The range of the width b of the light transmission portions may be equal or greater than (L₂−M₂) and equal or less than (L₂/0.62−M).

The image display portion may include left eye sub-pixel groups comprising of two sub-pixels corresponding to left eye images and right eye sub-pixel groups comprising of two sub-pixels corresponding to right eye images. The left eye sub-pixel groups and the right eye sub-pixel groups may be alternately and repeatedly arranged along the direction.

The range of the width of the left eye sub-pixel groups and the right eye pixel groups M₃ may be equal or greater than ½ times the pitch L₃ of the left eye sub-pixel groups and the right eye sub-pixel groups and less than the pitch L₃ of the left eye sub-pixel groups and the right eye sub-pixel groups. The range of the width b₃ of the light transmission portions may be equal or greater than (L₃−M₃) and equal or less than (L₃/0.62−M₃).

### BRIEF DESCRIPTION OF THE DRAWINGS

FIG. 1 is a schematic view of a three-dimensional display device according to an exemplary embodiment of the present invention.

FIG. 2 is a schematic view showing an optical path of the three-dimensional display device according to the exemplary embodiment of the present invention.

FIG. 3 is a schematic view showing an optical path when the width of the light transmission portion is small.

FIG. 4 is a schematic view showing an optical path when the width of the light transmission portion is large.

FIG. 5 is a graph showing the effect of cross-talk.

FIG. 6 is a schematic view showing a light control portion formed with a liquid crystal shutter.

FIG. 7 is a schematic view of a light control portion formed with a film type.

FIG. 8 is a schematic view of a three-dimensional display device according to an exemplary embodiment of the present invention.

FIG. 9 is a schematic view of a three-dimensional display device according to an exemplary embodiment of the present invention.

### DETAILED DESCRIPTION OF THE EMBODIMENTS

The present invention will be described more fully hereinafter with reference to the accompanying drawings, in which certain exemplary embodiments of the present invention are shown.

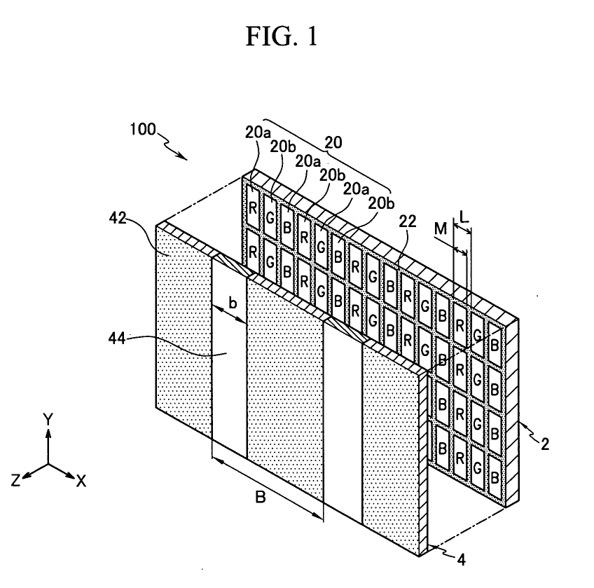

FIG. 1 is a schematic view of a three-dimensional display device according to a first exemplary embodiment of the present invention. As shown in FIG. 1, the three-dimensional display device 100 includes an image display portion 2 on which first sub-pixels 20a corresponding to left eye images and second sub-pixels 20b corresponding to right eye images are formed with a pattern and a light control portion 4 facing the image display portion 2. The light control portion 4 spatially separates the left eye images and the right eye images.

On the image display portion 2, sub-pixels 20 of red (R), green (G), and blue (B) are arranged repeatedly along a first direction (the X-axis direction in FIG. 1). The sub-pixels 20 having the same color as each other are arranged along a second direction that is perpendicular to the first direction (the Y-axis direction in FIG. 1).

The image display portion 2 displays the left eye images and the right eye images by the unit of a sub-pixel in such a way that right eye image signals and left eye image signals are input to the left eye and right eye sub-pixels 20a and 20b, respectively. In this case, a black matrix 22 is disposed between the left eye and right eye sub-pixels 20a and 20b in order to improve the contrast of the image display portion 2.

Any suitable display device may be applied for use as the image display portion 2. For instance, the image display portion 2 may be formed with a cathode ray tube, a liquid crystal display, a plasma display panel, a field emission display device, an organic electroluminescence display device, or any other suitable display device.

The light control portion 4 includes light interception portions 42 and light transmission portions 44 elongated along the second direction. Each of the light transmission portions 44 is located corresponding to at least two of the left eye and right eye sub-pixels 20a and 20b such that the light transmission portions 44 separate the left eye images and the right eye images displayed at the image display portion 2 into the left eye and the right eye of the user respectively.

Assuming that the pitch of the left eye and right eye sub-pixels 20a and 20b is L, the width of the left eye sub-pixels 20a and the right eye sub-pixels 20b, except for the black matrix 22, is M, and the average distance between the left and right eyes of a person is 65 mm, the range where a user can see a three-dimensional image is calculated as 65 mm×M/L.

If the left eye and the right eye of the user deviate from this range, then the user may feel dizzy. Thus, it is difficult for the user to see the three-dimensional image.

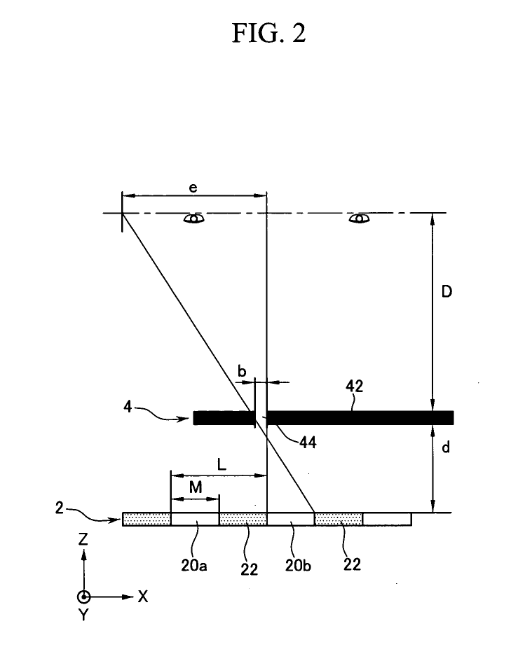

FIG. 2 shows the optical path of the three-dimensional display device according to the above exemplary embodiment. As shown in FIG. 2, a general three-dimensional display device satisfies the following Formula 1 and Formula 2.

Herein, b is the width of the light transmission portion 44, d is the distance between the image display portion 2 and the light control portion 4, D is the distance between the light control portion 4 and the user.
L/2≦M<L Formula 1:
D/d>100 Formula 2:

In addition, the range e where the user can see the three-dimensional image may be calculated by the following Formula 3.

$$Formula 3 \text{:}$$

$$e = \frac{b ( D + d ) + MD}{d}$$

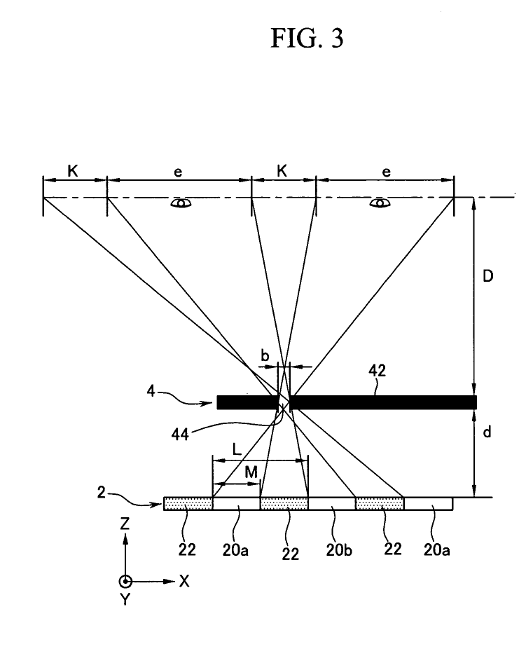

FIG. 3 shows an optical path of the three-dimensional display device when the width of the light transmission portion is relatively small. As shown in FIG. 3, when b is small, there is a range K where the black matrix 22 can be seen. That is, when the eyes of the user are located in the range K, the image seen by the user is darkened.

Even if the size of the range K is very small, the user can notice the black matrix 22. Accordingly, the minimum width b of the light transmission portion 44 should be defined in such a way to eliminate the range K.

The size of K is calculated as follows.

$$Formula 4 \text{:}$$

$$K = \frac{( L - M ) D - b ( D + d )}{d}$$

In order to eliminate K, the value of K should be zero or less. Thus, the range of b is calculated as follows.

$$Formula 5 \text{:}$$

$$b \geq \frac{( L - M ) D}{D + d}$$

We can assume that D≈D+d from Formula 2, thus Formula 5 yields the following Formula 6.
b≧L−M Formula 6:

As a result, the minimum width of the light transmission portion 44 is defined as Formula 6 above. The maximum width of the light transmission portion 44 will be calculated hereinafter.

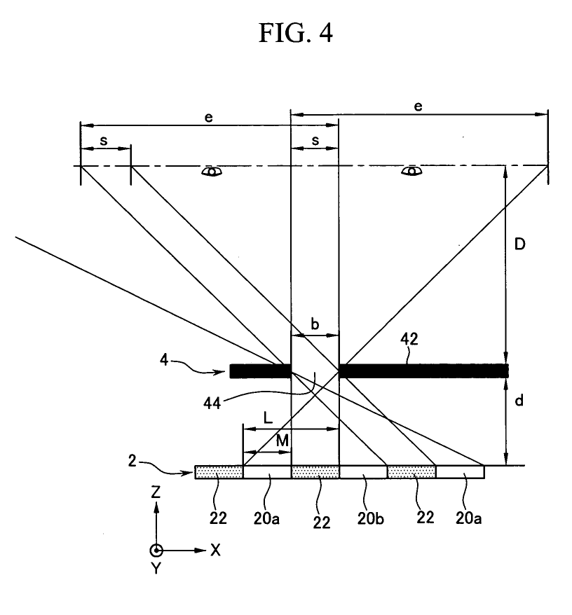

FIG. 4 shows an optical path when the width b of the light transmission portion 44 is more than the minimum value obtained by Formula 6.

A value of a cross-talk area s is calculated as follows.

$$Formula 7 \text{:}$$

$$s = \frac{b ( D + d ) - ( L - M ) D}{d}$$

When the eyes of the user are located in the cross-talk area s, the image appears vague. Thus, the user may feel dizzy. However, since the left and right images have Gaussian profiles, it is possible for the user to see the three-dimensional image in spite of some cross-talk. On the other hand, when the cross-talk is severe, it is impossible for the user to see the three-dimensional image due to the dizziness.

An experiment was conducted to determine the effects of the cross-talk on subjects watching a three-dimensional image. The subjects included people who had experienced three-dimensional displays at least one time. The experiment was conducted in such a way that the point at which each of the subjects can hardly see the three-dimensional image was investigated while gradually increasing cross-talk.

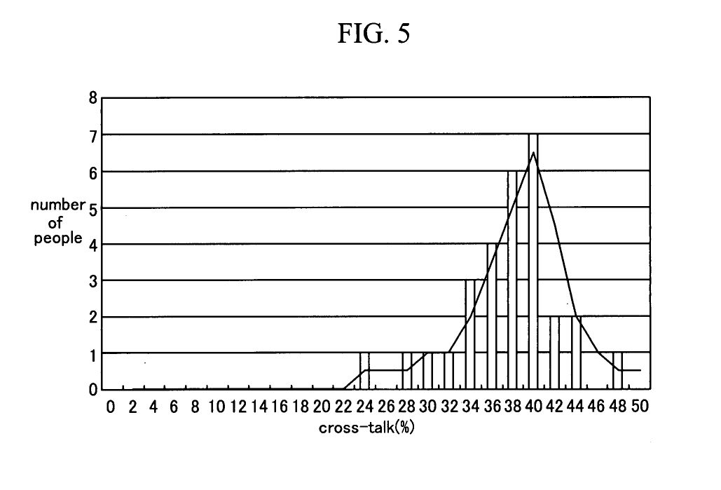

FIG. 5 is a graph showing the results of the experiment. The cross-talk is expressed as the percentage of the cross-talk area s to viewing area e. The number of subjects was 29 and the experiment was conducted twice. The values of FIG. 5 are average values for each of the subjects.

In the experiment, it was found that a user can see three-dimensional images until the cross-talk becomes 38% without feeling dizzy. That is, the user can watch three-dimensional images when the following condition is satisfied.
s/e≦0.38 Formula 8:

From Formulas 2, 3, and 7, Formula 8 can be expressed as follows.

$$Formula 9 \text{:}$$

$$b \leq \frac{L}{0.62} - M$$

Accordingly, the range of width b of the light transmission portions 44 where the user can see high quality three-dimensional images while minimizing deterioration of brightness of the three-dimensional display device is expressed as follows, from Formulas 6 and 9.

$$Formula 10 \text{:}$$

$$( L - M ) \leq b \leq \frac{L}{0.62} - M$$

Thus, assuming that the pitch of the light control portion 4 is B, the aperture ratio b/B of the light control portion 4 is calculated as follows.

$$Formula 11 \text{:}$$

$$0.25 \leq \frac{b}{B} \leq 0.55$$

Accordingly, the three-dimensional image having a wide viewing range and high brightness can be provided by defining the width of the light transmission portion 44.

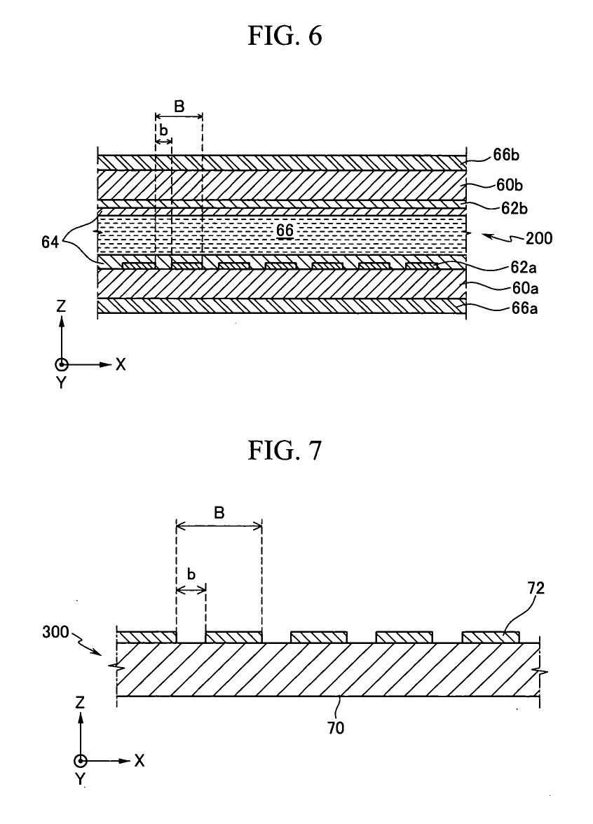

FIG. 6 is a schematic view showing a light control portion formed with a liquid crystal shutter, according to one embodiment of the invention. The liquid crystal shutter 200 includes: a first substrate 60a and a second substrate 60b facing each other; a first electrode 62a and a second electrode 62b formed on the inner surfaces of the first substrate 60a and the second substrate 60b respectively; a pair of alignment layers 64 covering the first electrode 62a and the second electrode 62b respectively; a liquid crystal layer 66 disposed between the pair of alignment layers 64; and a first polarization plate 66a and a second polarization plate 66b attached to the outer surfaces of the first substrate 60a and the second substrate 60b respectively.

One of the first electrode 62a and the second electrode 62b has the same pattern as that of the light interception portions 42 as described in FIG. 1. FIG. 6 shows that the first electrode 62a has the same pattern as that of the light interception portions 42 of FIG. 1, as an example.

When a driving voltage is applied to the first electrode 62a and the second electrode 62b, the array of liquid crystal molecules of the liquid crystal layer 66 is changed on the portions where the first electrode 62a is located such that the light from the image display portion is blocked. The portions of the liquid crystal shutter 200, where the first electrode 62a is not located operate as a light transmission portion. Accordingly the width b of the portions where the first electrode 62a is not located also satisfies Formula 10.

When the light control portion is formed with the liquid crystal shutter 200, a two-dimensional mode can be embodied by inputting the image signal to the left eye and right eye sub-pixels 20a and 20b and turning off the entire liquid crystal shutter 200.

FIG. 7 is a schematic view of a light control portion formed as a film type according to one embodiment of the invention. As shown in FIG. 7, the light control portion 300 includes a transparent plate 70 and an opaque layer 72 located on the surface of the transparent plate 70. The opaque layer 72 has the same pattern as the light interception portions 42 of FIG. 1 described above.

The opaque layer 72 corresponds to the light interception portions, and the parts of the transparent plate 70 on which the opaque layer 72 is not located correspond to the light transmission portions. The width b of the parts where the opaque layer 72 is not located also satisfies Formula 10.

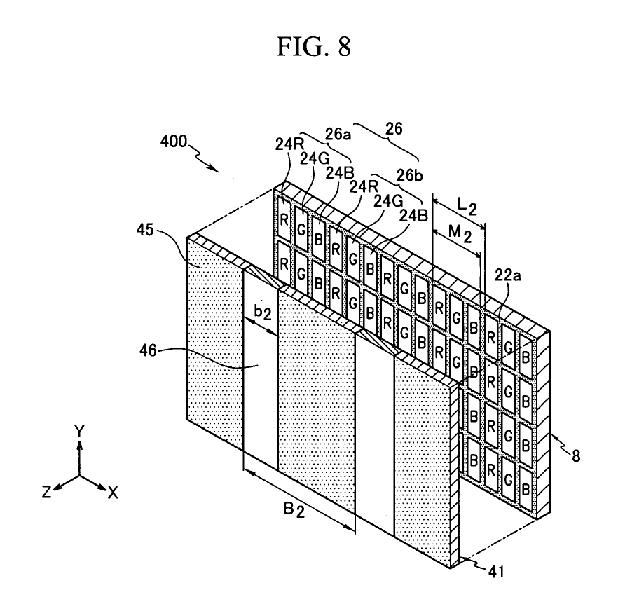

FIG. 8 shows a three-dimensional display device according to an exemplary embodiment of the present invention. As shown in FIG. 8, the three-dimensional display device 400 includes an image display portion 8 and a light control portion 41 facing the image display portion 8. The image display portion 8 includes first pixels 26a consisting of three sub-pixels 24R, 24G, and 24B corresponding to left eye images and second pixels 26b consisting of three sub-pixels 24R, 24G, and 24B corresponding to right eye images. The first pixels 26a and the second pixels 26b are arranged in a pattern on the image display portion 8. The light control portion 41 spatially separates the left eye images and the right eye images displayed at the image display portion 8. The light control portion 41 includes light interception portions 45 and light transmission portions 46 elongated along a second direction (a Y-axis direction of FIG. 8).

In one embodiment, the image display portion 8 displays the left eye images and the right eye images by the unit of a pixel in such a way that right eye image signals and left eye image signals are input to the first and second pixels 26a, 26b alternately and repeatedly. In this case, a black matrix 22a is disposed between the first and second pixels 26a and 26b in order to improve the contrast of the image display portion 8.

Assuming that the pitch of the first and second pixels 26a and 26b is L₂, that the width of the first and second pixels 26a and 26b is M₂, and that the average distance between the left and right eyes of a person is 65 mm, the range where a user can see a three-dimensional image is determined as 65 mm×M₂/L₂.

In the above exemplary embodiment of the present invention, the range of the width b₂ of the light transmission portions 46 can be calculated from the conditions described in the first exemplary embodiment as follows.

$$Formula 12 \text{:}$$

$$( {L}_{2} - {M}_{2} ) \leq {b}_{2} \leq \frac{{L}_{2}}{0.62} - {M}_{2}$$

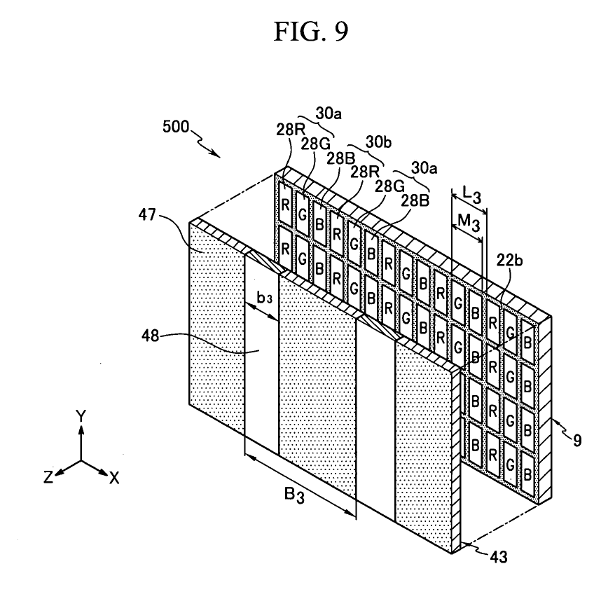

FIG. 9 shows a three-dimensional display device according to an exemplary embodiment of the present invention 500. As shown in FIG. 9, the three-dimensional display device 500 includes an image display portion 9 and a light control portion 43 facing the image display portion 9. The image display portion 9 includes first sub-pixel groups 30a consisting of two sub-pixels corresponding to left eye images and second sub-pixel groups 30b consisting of two sub-pixels corresponding to right eye images.

The light control portion 43 spatially separates the left eye images and the right eye images displayed at the image display portion 9. The light control portion 43 includes light interception portions 47 and light transmission portions 48 elongated along a second direction (a Y-axis direction in FIG. 9).

The image display portion 9 displays the left eye images and the right eye images by the unit of a sub-pixel group consisting of two sub-pixels in such a way that right eye image signals and left eye image signals are respectively input to the first and second sub-pixel groups 30a and 30b. In this case, a black matrix 22b is disposed between the first and second sub-pixel groups 30a and 30b in order to improve the contrast of the image display portion 9.

Assuming that the pitch of the sub-pixel groups 30a and 30b is L₃, the width of the first and second sub-pixel groups 30a and 30b is M₃, and the average distance between left and right eyes of a person is 65 mm, the range where a user can see a three-dimensional image is determined as 65 mm×M₃/L₃.

In the above exemplary embodiment of the present invention, the range of the width b₃ of the light transmission portions 48 can be calculated from the conditions described in the first exemplary embodiment as follows.

$$Formula 13 \text{:}$$

$$( {L}_{3} - {M}_{3} ) \leq {b}_{3} \leq \frac{{L}_{3}}{0.62} - {M}_{3}$$

With the three-dimensional display device of the present invention, high quality three-dimensional images that have a wide viewing range and high brightness can be provided.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A three-dimensional display device comprising:
an image display portion including sub-pixels corresponding to left eye images and sub-pixels corresponding to right eye images; and
a light control portion facing the image display portion, wherein the light control portion includes light interception portions and light transmission portions alternately and repeatedly arranged along a first direction of the image display portion, and wherein
the range of the width M of the sub-pixels is equal or greater than ½ times the pitch L of the sub-pixels and less than the pitch L of the sub-pixels, and
the range of the width of the light transmission portions is equal or greater than (L−M) and equal or less than (L/0.62−M).

2. The three-dimensional display device of claim 1, wherein the light control portion is formed with a liquid crystal shutter.

3. The three-dimensional display device of claim 2, wherein the liquid crystal shutter includes:
a first substrate;
a second substrate facing the first substrate;
first and second electrodes located on the inner surfaces of the first and second substrates, respectively;
a pair of alignment layers covering the first and second electrodes; and
a liquid crystal layer disposed between the alignment layers, wherein one of the first and second electrodes is formed in a same pattern as that of the light interception portions.

4. The three-dimensional display device of claim 1, wherein the light control portion includes a transparent plate and an opaque layer located on a surface of the transparent plate, and the opaque layer is formed in a same pattern as that of the light interception portions.

5. The three-dimensional display device of claim 1, wherein the light interception portions and the light transmission portions have a stripe pattern elongated along a second direction that is perpendicular to the first direction.

6. The three-dimensional display device of claim 1, wherein the sub-pixels corresponding to the left eye images and the sub-pixels corresponding to the right eye images are alternately and repeatedly arranged along the first direction.

7. The three-dimensional display device of claim 1, wherein the aperture ratio of the light control portion has a range of equal or greater than 0.25 and equal or less than 0.55.

8. A three-dimensional display device comprising:
an image display portion including pixels corresponding to left eye images and pixels corresponding to right eye images; and
a light control portion facing the image display portion, wherein the light control portion includes light interception portions and light transmission portions alternately and repeatedly arranged,
the image display portion includes left eye pixels comprising of three sub-pixels corresponding to the left eye images and right eye pixels comprising of three sub-pixels corresponding to the right eye images,
the left eye pixels and the right eye pixels alternately and repeatedly arranged along a first direction,
the range of the width M₂ of the pixels is equal or greater than ½ times the pitch L₂ of the left eye pixels and the right eye pixels and less than the pitch L₂, and
the range of the width of the light transmission portions is equal or greater than (L₂−M₂) and equal or less than (L₂/0.62−M).

9. The three-dimensional display device of claim 8, wherein the light control portion is formed with a liquid crystal shutter.

10. The three-dimensional display device of claim 9, wherein the liquid crystal shutter includes:
a first substrate;
a second substrate facing the first substrate;
first and second electrodes located on the inner surfaces of the first and second substrates, respectively;
a pair of alignment layers covering the first and second electrodes; and
a liquid crystal layer disposed between the alignment layers, wherein one of the first and second electrodes is formed in a same pattern as that of the light interception portions.

11. The three-dimensional display device of claim 8, wherein the light control portion includes a transparent plate and an opaque layer located on a surface of the transparent plate, and the opaque layer is formed in a same pattern as that of the light interception portions.

12. The three-dimensional display device of claim 8, wherein the light interception portions and the light transmission portions have a stripe pattern elongated along a second direction that is perpendicular to the first direction.

13. A three-dimensional display device comprising:
an image display portion including sub-pixels corresponding to left eye images and sub-pixels corresponding to right eye images; and
a light control portion facing the image display portion, wherein
the light control portion includes light interception portions and light transmission portions alternately and repeatedly arranged along a first direction of the image display portion,
the image display portion includes left eye sub-pixel groups comprising of two sub-pixels corresponding to left eye images and right eye sub-pixel groups comprising of two sub-pixels corresponding to right eye images,
the left eye sub-pixel groups and the right eye sub-pixel groups are alternately and repeatedly arranged along the first direction,
the range of the width M₃ of the left eye sub-pixel groups and the right eye sub-pixel groups is equal or greater than ½ times the pitch L₃ of the left eye sub-pixel groups and the right eye sub-pixel groups and less than the pitch L₃, and
the range of the width of the light transmission portions is equal or greater than (L₃−M₃) and equal or less than (L₃/0.62−M₃).

14. The three-dimensional display device of claim 13, wherein the light control portion is formed with a liquid crystal shutter.

15. The three-dimensional display device of claim 14, wherein the liquid crystal shutter includes:
a first substrate;
a second substrate facing the first substrate;
first and second electrodes located on the inner surfaces of the first and second substrates, respectively;
a pair of alignment layers covering the first and second electrodes; and
a liquid crystal layer disposed between the alignment layers, wherein one of the first and second electrodes is formed in a same pattern as that of the light interception portions.

16. The three-dimensional display device of claim 13, wherein the light control portion includes a transparent plate and an opaque layer located on a surface of the transparent plate, and the opaque layer is formed in a same pattern as that of the light interception portions.

17. The three-dimensional display device of claim 13, wherein the light interception portions and the light transmission portions have a stripe pattern elongated along a second direction that is perpendicular to the first direction.
